(19) United States
(12) Patent Application Publication
(10) Pub. No.: US 2026/0027505 A1
(43) Pub. Date: Jan. 29, 2026

(54) SCRUBBER FOR GEOTHERMAL POWER GENERATION AND GEOTHERMAL POWER GENERATION SYSTEM THEREWITH

(71) Applicant: FUJI ELECTRIC CO., LTD., Kawasaki-shi (JP)

(72) Inventor: Taichiro KATO, Musashino-city (JP)

(73) Assignee: FUJI ELECTRIC CO., LTD., Kawasaki-shi (JP)

(21) Appl. No.: 19/222,282

(22) Filed: May 29, 2025

(30) Foreign Application Priority Data
Jul. 24, 2024 (JP) 2024-118591

(51) Int. Cl. B01D 47/06; F24T 10/20; H02K 7/18

(52) U.S. Cl. CPC B01D 47/06; H02K 7/1823; F24T 10/20

(57) ABSTRACT

A scrubber for geothermal power generation, includes a treatment container, a drainage pipe, and a cooling mechanism. The treatment container separates geothermal steam into a separated gas and a separated liquid by treating the geothermal steam with a treatment liquid and has a steam supply opening to which the geothermal steam is supplied, and a gas release opening from which the separated gas is released. The drainage pipe is placed below the treatment container to discharge the separated liquid. The cooling mechanism cools a portion of the treatment container between the steam supply opening and the drainage pipe.

### CROSS REFERENCE TO RELATED APPLICATION

This application claims priority from Japanese Patent Application No. 2024-118591, filed Jul. 24, 2024, the entire content of which is incorporated herein by reference.

### BACKGROUND OF THE INVENTION

### Field of the Invention

The present disclosure relates to the field of geothermal power generation.

### Description of Related Art

Geothermal steam used for geothermal power generation contains impurities, such as silica and sulfides. To address this, techniques have been developed to remove these impurities from geothermal steam. For example, Patent Document 1 (Japanese Utility Model Application Laid-Open Publication No. H03-83615) discloses that impurities in geothermal steam from a supply pipe are trapped by waterdrops from a water injection nozzle. The waterdrops containing the trapped impurities are discharged from a discharge pipe coupled to the bottom of a separator.

In the technique disclosed in Patent Document 1, however, heating using geothermal steam may cause liquid containing impurities to transform into mist. This mist containing impurities rises and mixes with the geothermal steam, which ultimately transports the impurities with the geothermal steam to power-generating facilities. Adhesion and deposition of the impurities (generation of scale) on turbines in the power-generating facilities may reduce power generation efficiency, as well as the total amount of generated power. In view of the above circumstances, one aspect of the present disclosure has as an object to suppress a separated liquid containing impurities from being mixed in geothermal steam.

### SUMMARY

In order to solve the above problem, a scrubber for geothermal power generation according to one aspect of this disclosure includes a treatment container, a drainage pipe, and a cooling mechanism. The treatment container separates geothermal steam into a separated gas and a separated liquid by treating the geothermal steam with a treatment liquid and has a steam supply opening to which the geothermal steam is supplied, and a gas release opening from which the separated gas is released. The drainage pipe is placed below the treatment container to discharge the separated liquid. The cooling mechanism cools a portion of the treatment container between the steam supply opening and the drainage pipe.

A geothermal power generation system according to another aspect of this disclosure includes a production well that generates geothermal steam, a scrubber for geothermal power generation, and a power-generating facility. The scrubber includes (i) a treatment container that separates the generated geothermal steam into a separated gas and a separated liquid by treating the geothermal steam with a treatment liquid and has a steam supply opening to which the geothermal steam is supplied, and a gas release opening from which the separated gas is released, (ii) a drainage pipe placed below the treatment container to discharge the separated liquid, and (iii) a cooling mechanism that cools a portion of the treatment container between the steam supply opening and the drainage pipe. The power-generating facility generates power, using the separated gas.

### BRIEF DESCRIPTION OF THE DRAWINGS

FIG. 1 is a block diagram illustrating a configuration of a geothermal power generation system according to a first embodiment.

FIG. 2 illustrates a configuration of a scrubber for geothermal power generation according to the first embodiment.

FIG. 3 illustrates a configuration of a scrubber for geothermal power generation according to a second embodiment.

FIG. 4 illustrates a configuration of a scrubber for geothermal power generation according to a third embodiment.

FIG. 5 illustrates a configuration of a scrubber for geothermal power generation according to a fourth embodiment.

FIG. 6 describes a relationship between an internal pressure of a treatment container and an opening degree of an adjustment valve.

FIG. 7 illustrates a configuration of a scrubber for geothermal power generation according to a fifth embodiment.

FIG. 8 illustrates a relationship between a liquid level of a separated liquid and an opening degree of the adjustment valve.

FIG. 9 illustrates a configuration of a scrubber for geothermal power generation according to a sixth embodiment.

FIG. 10 illustrates a configuration of a scrubber for geothermal power generation according to a comparative example.

### DESCRIPTION OF THE EMBODIMENTS

Embodiments for the present disclosure are explained with reference to the drawings. The embodiments explained below are merely examples for implementing the present disclosure. Therefore, the scope of the present disclosure is not limited to the embodiments shown below.

### A: FIRST EMBODIMENT

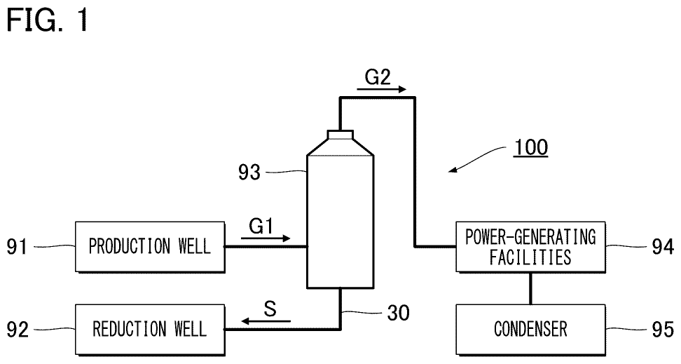

FIG. 1 is a block diagram illustrating a configuration of a geothermal power generation system 100 according to a first embodiment. The geothermal power generation system 100 is a renewable energy power plant using geothermal energy. The geothermal power generation system 100 of the first embodiment includes a production well 91, a reduction well 92, a scrubber 93 for geothermal power generation, power-generating facilities 94, and a condenser 95. The geothermal power generation system 100 may include a variety of facilities other than those shown in FIG. 1.

The production well 91 is used to generate geothermal steam G1. Specifically, the production well 91 is a geothermal well that draws steam and hot water from underground geothermal energy reservoirs. The geothermal steam G1 generated by the production well 91 contains particulate impurities, such as silica or sulfide, and is supplied to the scrubber 93.

The scrubber 93 is a gas-liquid separator that separates the geothermal steam G1 into separated gas G2 and separated liquid S. The separated gas G2 is high-pressure gas from which impurities in the geothermal steam G1 have been removed. The separated liquid S contains the impurities in the geothermal steam G1. Thus, the scrubber 93 is a cleaner that generates the separated gas G2 by cleaning the geothermal steam G1. The separated gas G2 generated by the scrubber 93 is supplied to the power-generating facilities 94.

The power-generating facilities 94 generate power with the separated gas G2. Specifically, the power-generating facilities 94 include a power generator (not illustrated) that generates power by rotating a turbine with the separated gas G2. The condenser 95 is a steam condenser that cools and condenses steam discharged from the power-generating facilities 94. Condensed warm water is discharged from the condenser 95.

The separated liquid S discharged from the scrubber 93 is supplied to the reduction well 92. The reduction well 92 reduces the separated liquid S to return the reduced liquid into the ground. The warm water discharged from the condenser 95 may also be supplied to the reduction well 92.

In the first embodiment, the separated gas G2 from which impurities in the geothermal steam G1 have been removed is supplied to the power-generating facilities 94. This avoids reduction in power generation efficiency, as well as the total amount of electricity produced, caused by adhesion and deposition of impurities on turbines or other components of power-generating facilities 94.

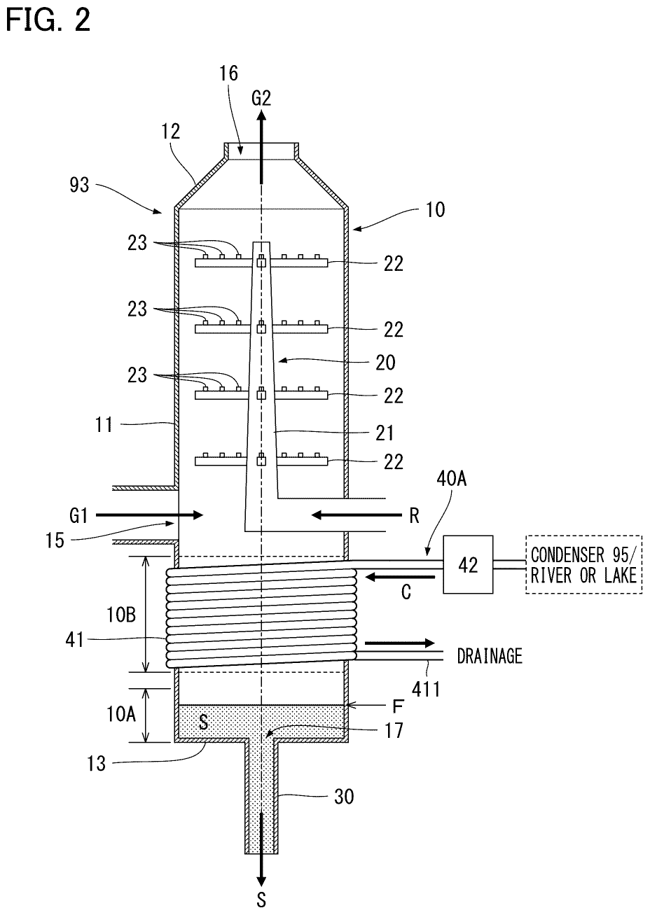

FIG. 2 illustrates a configuration of the scrubber 93. As illustrated in FIG. 2, the scrubber 93 of the first embodiment includes a treatment container 10, a liquid injector 20, a drainage pipe 30, and a cooling mechanism 40A.

The treatment container 10 is a reaction tower for separating the geothermal steam G1 into the separated gas G2 and the separated liquid S by treating the geothermal steam G1 with a treatment liquid R. The treatment container 10 is made from a material, such as a thermally conductive metallic material. The liquid injector 20 is a sprayer that injects the treatment liquid R in a mist form into the treatment container 10. The liquid injector 20 is installed inside the treatment container 10.

Specifically, the liquid injector 20 includes a trunk pipe 21 extending vertically, a plurality of branch pipes 22 extending radially from the trunk pipe 21, and a plurality of sprayers 23 placed on each of the branch pipes 22. Treatment liquid R is injected from each sprayer 23. The treatment liquid R is a cleaning solution for removing impurities from the geothermal steam G1, such as water.

The treatment container 10 of the first embodiment is a hollow structure including a sidewall 11, a top face 12, and a bottom 13. The sidewall 11 is substantially cylindrical around the vertical central axis. The top face 12 is a truncated cone portion coupled to a topmost part of the sidewall 11. The bottom 13 is a discoid portion closing a bottommost opening of the sidewall 11.

The treatment container 10 has a steam supply opening 15, a gas release opening 16, and a drainage opening 17. The steam supply opening 15 is used to supply geothermal steam G1 to the treatment container 10 and is on the sidewall 11 of the treatment container 10. The geothermal steam G1 enters into the treatment container 10 from the steam supply opening 15. The steam supply opening 15 is located on the sidewall 11 at a predetermined height. Specifically, the steam supply opening 15 is positioned at a preset distance vertically above the bottom 13.

The gas release opening 16 is used to release the separated gas G2 and is located on the top face 12 of the treatment container 10. In other words, the gas release opening 16 is positioned at the uppermost end of the treatment container 10. The geothermal steam G1 supplied from the steam supply opening 15 through the treatment container 10 rises, swirling along the inner circumferential surface of the sidewall 11. As the geothermal steam G1 rises, impurities in the geothermal steam G1 are removed by the treatment liquid R injected from the liquid injector 20. The geothermal steam G1 from which the impurities have been removed is released as the separated gas G2 to outside of the treatment container 10 from the gas release opening 16. The separated gas G2 released from the gas release opening 16 is supplied to the power-generating facilities 94. In addition, droplets of the treatment liquid R, which have trapped impurities from the geothermal steams G1, adhere to the inner circumferential surface of the sidewall 11 and descend by gravity, reaching the bottom 13 of the treatment container 10 as the separated liquid S containing the impurities.

The drainage pipe 30 is located below the treatment container 10. Specifically, the drainage pipe 30 is a conduit extending vertically downward from the bottom 13 of the treatment container 10 and is communicated with the drainage opening 17 of the bottom 13. As a result, the separated liquid S, which has reached the bottom 13, passes through the drainage pipe 30 and is discharged. This separated liquid S is then supplied to the reduction well 92.

In the first embodiment, as illustrated in FIG. 2, the separated liquid S is accumulated in a container bottom region 10A, which is defined as a region positioned vertically downward of the treatment container 10. Specifically, the liquid surface F of the separated liquid S is positioned vertically above the bottom 13. This means that the treatment container 10 has a liquid seal (a water seal) that is positioned at the container bottom region 10A and that is caused by accumulation of the separated liquid S. In one example, the flow rate of the separated liquid S flowing through the drainage pipe 30 is determined to form a water seal of the separated liquid S in the treatment container 10.

If there is no liquid seal at the container bottom region 10A (hereinafter, “first comparative example”), geothermal steam G1 may be discharged from the drainage pipe 30 along with the separated liquid S. If the geothermal steam G1 is discharged from the drainage pipe 30, this may reduce the supply of a sufficient amount of separated gas G2 to the power-generating facilities 94, leading to decrease in generated power. In the first embodiment, in contrast to the first comparative example, a liquid seal positioned at the container bottom region 10A suppresses discharge of the geothermal steam G1 to the drainage pipe 30. As a result, a decrease in the generated power due to discharge of the geothermal steam G1 to the drainage pipe 30 can be suppressed.

The cooling mechanism 40A is a mechanism that cools the treatment container 10. Specifically, the cooling mechanism 40A cools a cooling target 10B, which is a portion of the treatment container 10 and is located between the steam supply opening 15 and the drainage pipe 30. In the first embodiment, the cooling target 10B is located at a portion of the treatment container 10 between the steam supply opening 15 and the bottom 13. More specifically, the cooling target 10B is located at a portion of the treatment container 10 between the steam supply opening 15 and the liquid surface F of the separated liquid S.

As illustrated in FIG. 2, the cooling mechanism 40A of the first embodiment is a liquid cooling-type system that includes a cooling channel 41 and a supply mechanism 42. The cooling channel 41 is a conduit placed in vicinity of the treatment container 10. Specifically, the cooling channel 41 is helically wound on the cooling target 10B of the treatment container 10. Specifically, the cooling channel 41 is wound on a portion of the treatment container 10 between the steam supply opening 15 and the bottom 13 (more specifically, a portion between the steam supply opening 15 and the liquid surface F of the separated liquid S).

The supply mechanism 42 is a pump that supplies a coolant C to the cooling channel 41. In one example, the supply mechanism 42 supplies a liquid, condensed by the condenser 95, as the coolant C to the cooling channel 41. Alternatively, the supply mechanism 42 may draw water from a river, a lake, or a marsh located near the scrubber 93 for geothermal power generation, and it may supply the water as the coolant C to the cooling channel 41. The coolant C, after passing through the cooling channel 41 and undergoing heat exchange, is discharged to the outside via a drainage path 411.

In the first embodiment, a liquid seal caused by accumulation of the separated liquid S is formed at the container bottom region 10A of the treatment container 10. If there is no cooling target 10B (hereinafter, “second comparative example”), the separated liquid S accumulated in the bottom 13 of the treatment container 10 may be turned into a mist when heated by the geothermal steam G1 supplied to the treatment container 10. The misty separated liquid S containing impurities moves upward along with the geothermal steam G1 in the treatment container 10 and is consequently released from the gas release opening 16. That is, the separated liquid S containing impurities is supplied to the power-generating facilities 94 along with the separated gas G2. The impurities adhere and deposit on the turbines of the power-generating facilities 94 may reduce the power generation efficiency.

In the first embodiment, in contrast to the second comparative example, the cooling target 10B of the treatment container 10, located between the steam supply opening 15 and the drainage pipe 30, is cooled by the cooling mechanism 40A. Such a cooling results in suppression of the separated liquid S from turning into mist due to heating by the geothermal steam G1. As a result, steam of the separated liquid S containing impurities can be prevented from mixing with the geothermal steam G1 to be discharged from the gas release opening 16. Thus, according to the first embodiment, reduction in power generation efficiency, as well as the total amount of electricity produced, caused by the adhesion and deposition of impurities of power-generating facilities 94, can be suppressed.

### B: SECOND EMBODIMENT

A second embodiment of the present disclosure will be described below. In each mode exemplified below, elements substantially the same in functions as those described in the first embodiment are denoted by reference signs used in the explanations of the first embodiment, and detailed explanations thereof are omitted as appropriate.

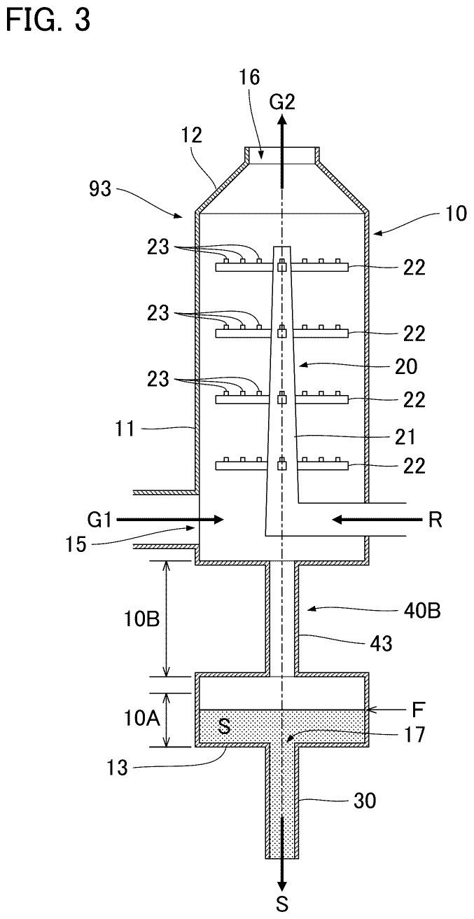

FIG. 3 illustrates a configuration of a scrubber 93 for geothermal power generation according to the second embodiment. In the first embodiment, an example is given of the cooling mechanism 40A, which is a liquid cooling-type system that includes the cooling channel 41 and the supply mechanism 42. In the second embodiment, the cooling mechanism 40A is replaced by a cooling mechanism 40B. The cooling mechanism 40B cools a cooling target 10B of the treatment container 10 between the steam supply opening 15 and the drainage pipe 30, similarly to the cooling mechanism 40A of the first embodiment. However, the cooling mechanism 40B of the second embodiment is an air-cooling type system that cools the cooling target 10B of the treatment container 10 by heat exchange with external air present outside the treatment container 10.

Specifically, the cooling mechanism 40B is a cooling pipe 43 of the treatment container 10 located between the steam supply opening 15 and the drainage pipe 30. In a portion of the treatment container 10 located above the cooling pipe 43, the geothermal steam G1 is treated with the treatment liquid R, resulting in generation of the separated liquid S. This separated liquid S then falls along the inner circumferential surface of the sidewall 11 of the treatment container 10 and passes through the cooling pipe 43. The cooling mechanism 40B cools the cooling target 10B of the treatment container 10 by heat exchange with external air (e.g., air) flowing around the cooling pipe 43. As illustrated in FIG. 3, the separated liquid S, after passing through the cooling pipe 43, accumulates in the container bottom region 10A, which is located below the cooling pipe 43, thereby forming a liquid seal.

The second embodiment can also provide effects similar to those of the first embodiment. In the second embodiment, the treatment container 10 is cooled by the cooling mechanism 40B of the air-cooling type including the cooling pipe 43. As a result, the second embodiment achieves a simple configuration for cooling the cooling target 10B of the treatment container 10, as compared to the first embodiment using the cooling mechanism 40A of a liquid cooling type.

In contrast, in the first embodiment, the cooling target 10B of the treatment container 10 is cooled by the cooling mechanism 40A of a liquid cooling type using the coolant C flowing through the cooling channel 41. As a result, in the first embodiment, the cooling target 10B of the treatment container 10 is cooled more effectively and more stably, as compared to the second embodiment using the cooling mechanism 40B of the air-cooling type.

### C: THIRD EMBODIMENT

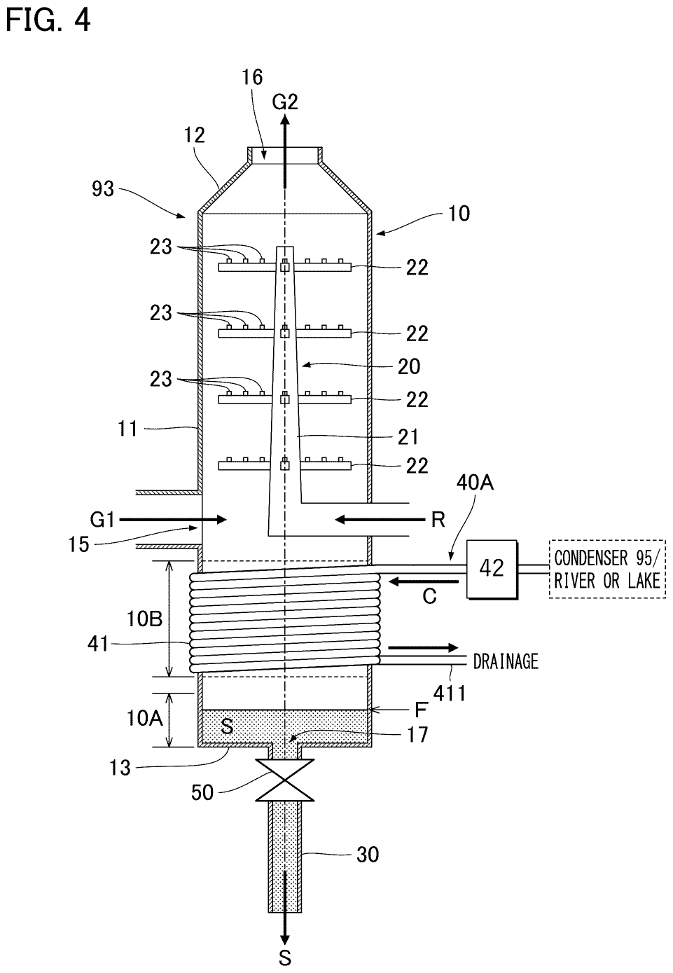

FIG. 4 illustrates a configuration of a scrubber 93 for geothermal power generation according to a third embodiment. As illustrated in FIG. 4, the scrubber 93 of the third embodiment includes an adjustment valve 50 in addition to components substantially the same as those in the first embodiment.

The adjustment valve 50 is placed on a flow path between the treatment container 10 and the drainage pipe 30. The adjustment valve 50 adjusts the flow rate of the separated liquid S supplied from the treatment container 10 to the drainage pipe 30. A ball valve with a spherical rotatable ball is an example of the adjustment valve 50. A maintenance worker of the scrubber 93 adjusts an opening degree D of the adjustment valve 50 manually. The flow rate of the separated liquid S is adjusted based on the opening degree D.

Specifically, the opening degree D of the adjustment valve 50 is adjusted to enable a liquid seal to be formed by accumulation of the separated liquid S at the container bottom region 10A of the treatment container 10. That is, the adjustment valve 50 of the third embodiment forms a liquid seal by adjusting the flow rate of the separated liquid S supplied from the treatment container 10 to the drainage pipe 30.

The third embodiment can also provide effects similar to those of the first embodiment. In the third embodiment, a liquid seal is formed by adjustment of the flow rate with the adjustment valve 50, which is placed on the flow path between the treatment container 10 and the drainage pipe 30. As a result, a liquid seal by a desired liquid level can be stably formed. Specifically, preventing the accumulation of an excessive amount of the separated liquid S helps to prevent the separated liquid S from turning into mist and mixing with the geothermal steam G1.

### D: FOURTH EMBODIMENT

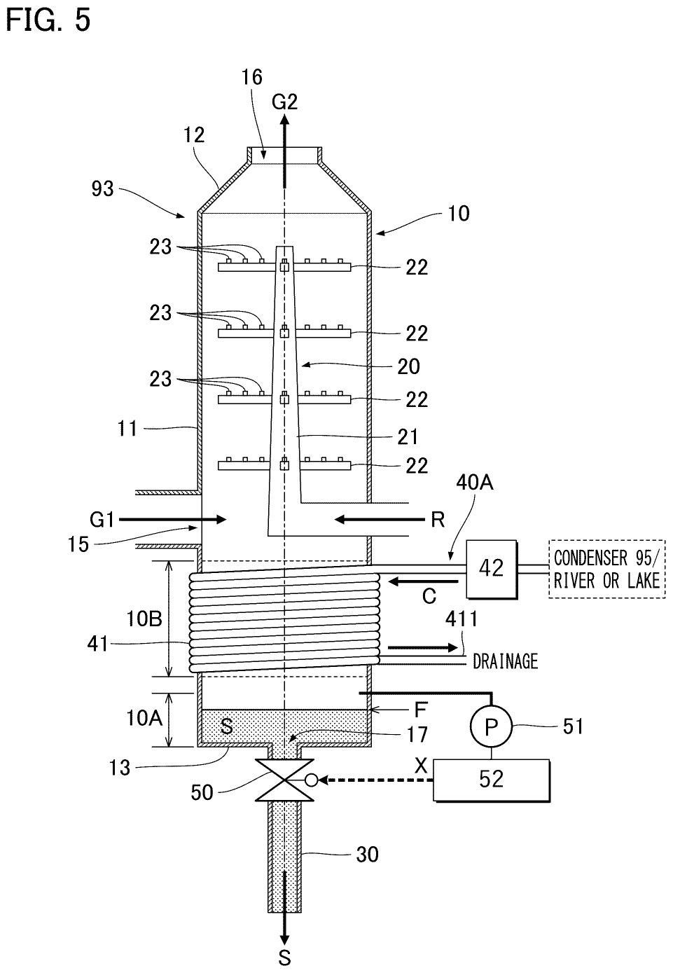

FIG. 5 illustrates a configuration of a scrubber 93 for geothermal power generation according to a fourth embodiment. The scrubber 93 of the fourth embodiment includes the adjustment valve 50 that is substantially the same as that in the third embodiment. The adjustment valve 50 of the fourth embodiment is an electromagnetic adjustment valve that controls the opening degree D based on a control signal X. That is, the adjustment valve 50 adjusts the flow rate of the separated liquid S supplied from the treatment container 10 to the drainage pipe 30 based on the control signal X.

As illustrated in FIG. 5, the scrubber 93 of the fourth embodiment includes a pressure gauge 51 and a controller 52 in addition to components substantially the same as those in the third embodiment. The pressure gauge 51 is a measuring device that measures an internal pressure P of the treatment container 10. Any method of measurement techniques can be used for measurement of the internal pressure P.

The controller 52 is a computer that controls the adjustment valve 50. The controller 52 comprises a processor, such as a CPU (Central Processing Unit) or a DSP (Digital Signal Processor), that executes a program stored in a storage device. The controller 52 outputs a control signal X to the adjustment valve 50 to control the opening degree D. The controller 52 of the fourth embodiment controls the opening degree D of the adjustment valve 50 based on a measurement result (i.e., the internal pressure P) obtained by the pressure gauge 51.

If the liquid seal at the container bottom region 10A of the treatment container 10 is broken due to shortage of the separated liquid S in the treatment container 10, the internal pressure P of the treatment container 10 is reduced. In such a case, the controller 52 decreases the opening degree D of the adjustment valve 50 to reduce the flow rate of the separated liquid S to the drainage pipe 30, thereby forming a liquid seal of the separated liquid S at the container bottom region 10A.

The fourth embodiment can also provide effects similar to those of the third embodiment. In the fourth embodiment, the opening degree D of the adjustment valve 50 is controlled based on the measurement result of the internal pressure P of the treatment container 10. Such control eliminates the need for manual adjustment of the adjustment valve 50 by the maintenance worker. According to the fourth embodiment, workload required to achieve a liquid seal with an appropriate liquid level can be minimized.

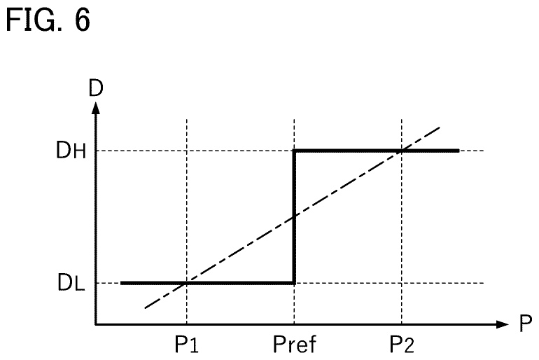

FIG. 6 describes control of the opening degree D of the adjustment valve 50 implemented by the controller 52 based on the internal pressure P. As illustrated in FIG. 6, when the internal pressure P measured by the pressure gauge 51 exceeds a threshold Pref, the controller 52 sets the adjustment valve 50 to an opening degree DH. Otherwise, that is, when the internal pressure P is less than the threshold Pref, the controller 52 sets the adjustment valve 50 to an opening degree DL, which is less than the opening degree DH. Thus, the flow rate of the separated liquid S is reduced when the internal pressure P is less than the threshold Pref, compared to when the internal pressure P exceeds the threshold Pref.

Attention is focused on a first value P1 and a second value P2, which are measurements of the internal pressure P obtained from the pressure gauge 51. The second value P2 represents a pressure that is greater than the first value P1 (P2>P1). As illustrated in FIG. 6, the controller 52 controls the opening degree D of the adjustment valve 50, ensuring that the opening degree DL when the internal pressure P is at the first value P1 is less than the opening degree DH when the internal pressure P is at the second value P2. The flow rate of the separated liquid S when the internal pressure P is at the first value P1 is less than that of the separated liquid S when the internal pressure P is at the second value P2.

As is clear from the description in the fourth embodiment, when the internal pressure P decreases from the second value P2 to the first value P1 due to breakage of a seal, the accumulated amount of the separated liquid S in the treatment container 10 is increased by a decrease (DH→DL) in the opening degree D of the adjustment valve 50. As a result, a liquid seal by an appropriate liquid level can be stably maintained.

In the foregoing explanation, an example is described in which the opening degree D of the adjustment valve 50 is changed in a binary manner with respect to the internal pressure P of the treatment container 10. However, the relationship between the internal pressure P and the opening degree D is not limited to such an example. For example, as indicated by a dash-dot line shown in FIG. 6, the controller 52 may control the opening degree D based on the internal pressure P, ensuring that the opening degree D changes continuously (e.g., linearly or curvilinearly) with respect to the internal pressure P of the treatment container 10.

### E: FIFTH EMBODIMENT

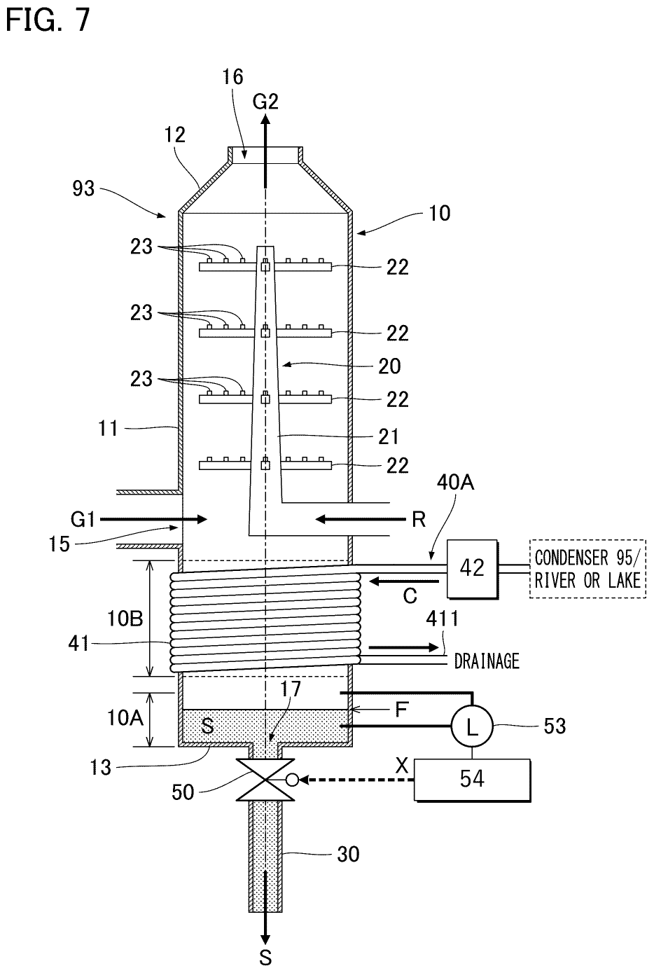

FIG. 7 illustrates a configuration of a scrubber 93 for geothermal power generation according to a fifth embodiment. The scrubber 93 of the fifth embodiment includes the adjustment valve 50 that controls the opening degree D based on the control signal X similarly to the fourth embodiment.

As shown in FIG. 7, the scrubber 93 of the fifth embodiment includes a liquid level meter 53 and a controller 54 in addition to components substantially the same as those in the third embodiment. The liquid level meter 53 is a level gauge that measures a liquid level L of the separated liquid S accumulated in the container bottom region 10A of the treatment container 10. The liquid level L shows a level of the liquid surface of the separated liquid S related to a predetermined reference surface (e.g., the surface of the bottom 13). Any method of measurement technique can be used to measure the liquid level L.

The controller 54 is a computer that controls the adjustment valve 50. Similarly to the fourth embodiment, the controller 54 comprises a processor, such as a CPU or a DSP, that executes a program stored in a storage device. The controller 54 outputs a control signal X to the adjustment valve 50 to control the opening degree D. The controller 54 of the fifth embodiment controls the opening degree D of the adjustment valve 50 based on a measurement result (i.e., the liquid level L) obtained from the liquid level meter 53.

When the liquid seal at the container bottom region 10A of the treatment container 10 is broken due to inadequate amount of the separated liquid S, the liquid level L of the separated liquid S is reduced. In such a case, the controller 54 decreases the opening degree D of the adjustment valve 50 to reduce the flow rate of the separated liquid S to the drainage pipe 30, thereby forming a liquid seal of the separated liquid S at the container bottom region 10A.

The fifth embodiment can also provide effects similar to those of the third embodiment. Furthermore, the opening degree D of the adjustment valve 50 is controlled based on the measurement result of the liquid level L. Such control eliminates the need for manual adjustment of the adjustment valve 50 by the maintenance worker. According to the fifth embodiment, workload required to achieve a liquid seal with an appropriate liquid level L is reduced.

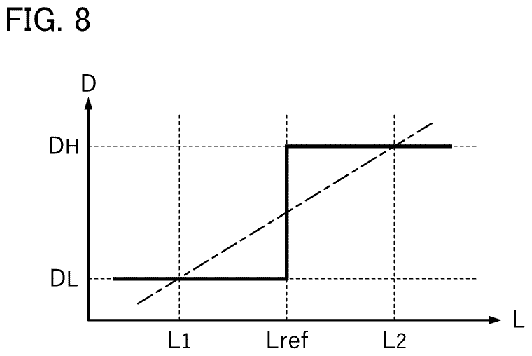

FIG. 8 describes control of the opening degree D of the adjustment valve 50 implemented by the controller 54 based on the liquid level L. As illustrated in FIG. 8, when the liquid level L measured by the liquid level meter 53 exceeds a threshold Lref, the controller 54 sets the adjustment valve 50 to an opening degree DH. Otherwise, that is, when the liquid level Lis less than the threshold Lref, the controller 54 sets the adjustment valve 50 to an opening degree DL, which is less than the opening degree DH. Thus, the flow rate of the separated liquid S id reduced when the liquid level L is less than the threshold Lref, compared to when the liquid level L exceeds the threshold Lref.

Attention is focused on a first value L1 and a second value L2, which are measurements of the liquid level L obtained from the liquid level meter 53. The second value L2 represents a measurement that is greater than the first value L1 (L2>L1). As illustrated in FIG. 8, the controller 54 controls the opening degree D of the adjustment valve 50, ensuring that the opening degree DL when the liquid level Lis at the first value L1 is less than the opening degree DH when the liquid level L is at the second value L2. The flow rate of the separated liquid S when the liquid level L is at the first value L1 is less than that of the separated liquid S when the liquid level Lis at the second value L2.

As is clear from the description in the fifth embodiment, when the liquid level L decreases from the second value L2 to the first value L1 due to breakage of a seal, the accumulated amount of the separated liquid S in the treatment container 10 is increased by a decrease (DH→DL) in the opening degree D of the adjustment valve 50. As a result, a liquid seal at an appropriate liquid level can be stably maintained.

In the foregoing explanation, an example is described in which the opening degree D of the adjustment valve 50 is changed in a binary manner with respect to the liquid level L of the separated liquid S. However, the relationship between the liquid level L and the opening degree D is not limited to such an example. For example, as indicated by dash-dot line shown in FIG. 8, the controller 54 may control the opening degree D of the adjustment valve 50 based on the liquid level L, ensuring that the opening degree D changes continuously (e.g., linearly or curvilinearly) with respect to the liquid level L in the treatment container 10.

### F: SIXTH EMBODIMENT

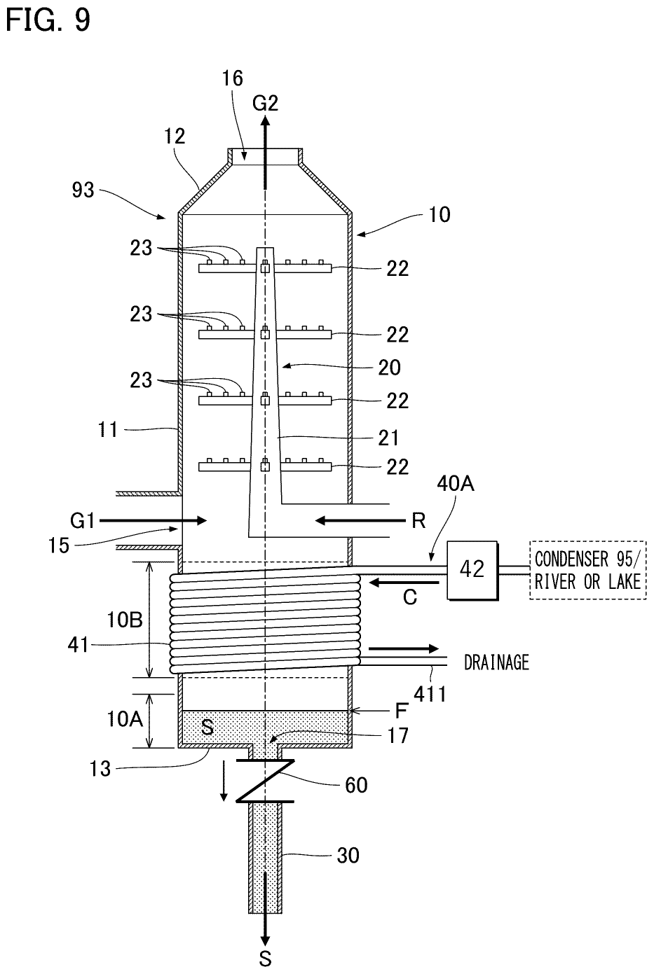

FIG. 9 illustrates a configuration of the scrubber 93 for geothermal power generation according to a sixth embodiment. The scrubber 93 of the sixth embodiment includes a check valve 60 in addition to components substantially the same as those in the first embodiment. The check valve 60 is placed on a flow path between the treatment container 10 and the drainage pipe 30. The check valve 60 is a device that prevents backflow of the separated liquid S from the drainage pipe 30 toward the treatment container 10. A structure of the check valve 60 may be freely selected.

The sixth embodiment can also provide effects similar to those of the first embodiment. Furthermore, the check valve 60 is placed between the treatment container 10 and the drainage pipe 30 in the sixth embodiment. Such placement of the check valve 60 prevents backflow of the separated liquid S from the drainage pipe 30 toward the treatment container 10. The check valve 60 of the sixth embodiment is applicable to any of the first to fifth embodiments.

### G: MODIFICATIONS

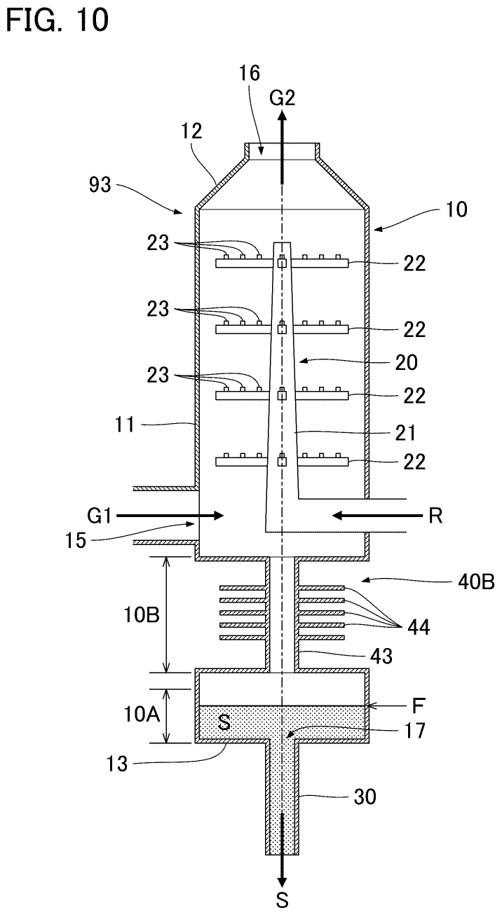

Some modifications described below are derived from the foregoing embodiments. Two or more modes optionally selected from the following modifications may be combined with one another as appropriate, as long as they do not conflict.
(1) The foregoing third to sixth embodiments are designed based on the cooling mechanism 40A of the first embodiment. However, in the third to sixth embodiments, the cooling mechanisms 40A may be replaced with the cooling mechanism 40B described in the second embodiment.
   Alternatively, the cooling mechanisms 40 (40A, 40B) may be omitted in the third to sixth embodiments.
(2) In the foregoing embodiments, the container bottom region 10A and the cooling target 10B in the treatment container 10 do not overlap vertically. However, the container bottom region 10A and the cooling target 10B may overlap vertically. In one example, the cooling mechanisms 40 (40A, 40B) may cool a part or all of the container bottom region 10A as the cooling target 10B.
(3) In the second embodiment, the cooling mechanism 40B of the air-cooling type includes the cooling pipe 43. One or more cooling fins 44 may be placed on the cooling pipe 43 as shown in FIG. 10. According to the configuration illustrated in FIG. 10, heat exchange between the cooling pipe 43 and external air is promoted and therefore the separated liquid S in the cooling pipe 43 can be efficiently cooled.
(4) Descriptions “nth” (n is a natural number) in this application are used only as formal and expedient indicators (labels) to distinguish the components from each other by the notation and do not have any substantive meaning. The position, order, or the like of each component cannot be interpreted in a limited manner on the grounds of the notation “nth.”

### H: APPENDICES

The following configurations are derived from the foregoing embodiments.

A scrubber for geothermal power generation according to one aspect (Aspect 1) of this disclosure includes: a treatment container that: separates geothermal steam into a separated gas and a separated liquid by treating the geothermal steam with a treatment liquid; and has a steam supply opening to which the geothermal steam is supplied, and a gas release opening from which the separated gas is released; a drainage pipe placed below the treatment container to discharge the separated liquid; and a cooling mechanism that cools a portion of the treatment container between the steam supply opening and the drainage pipe.

According to this aspect, the portion of the treatment container between the steam supply opening and the drainage pipe is cooled by the cooling mechanism. Such a cooling results in suppression of the separated liquid from turning into mist due to heating by the geothermal steam. As a result, steam of the separated liquid containing impurities can be prevented from mixing with the geothermal steam to be discharged from the gas release opening.

In an example (Aspect 2) of Aspect 1, the cooling mechanism includes: a cooling channel placed in the vicinity of the treatment container; and a supply mechanism that supplies a coolant to the cooling channel.

In this aspect, the treatment container is cooled by heat exchange with the coolant supplied to the cooling channel. As compared to when the treatment container is cooled by an air-cooling mechanism, the treatment container can be cooled more effectively and more stably.

In an example (Aspect 3) of Aspect 1, the cooling mechanism is an air-cooling mechanism that cools the treatment container by heat exchange with external air.

In this aspect, the treatment container is cooled by the air-cooling mechanism. As a result, compared to when the treatment container is cooled by a liquid-cooling mechanism, the treatment container can be cooled with a simpler configuration.

In an example (Aspect 4) of any of Aspects 1 to 3, the treatment container has a liquid seal caused by accumulation of the separated liquid, and the liquid seal is positioned vertically downward of the treatment container.

In this aspect, a liquid seal is formed vertically downward of the treatment container. As a result, compared to when there is no liquid seal in the treatment container, the geothermal steam is prevented from being discharged to the drainage pipe.

In an example (Aspect 5) of Aspect 4, the scrubber further includes an adjustment valve placed on a flow path between the treatment container and the drainage pipe. The adjustment valve forms the liquid seal by adjusting a flow rate of the separated liquid supplied from the treatment container to the drainage pipe.

In this aspect, a liquid seal is formed by adjustment of the flow rate using the adjustment valve placed on a flow path between the treatment container and the drainage pipe. As a result, a liquid seal at a desired liquid level can be stably formed. Specifically, preventing the accumulation of an excessive amount of the separated liquid helps to prevent the separated liquid from turning into mist and mixing with the geothermal steam.

In an example (Aspect 6) of Aspect 5, the scrubber further includes a pressure gauge that measures an internal pressure of the treatment container; and a controller configured to control an opening degree of the adjustment valve based on a measurement result of the pressure gauge.

In this aspect, the opening degree of the adjustment valve is controlled based on the measurement result of the internal pressure of the treatment container. Such control eliminates the need for manual adjustment of the adjustment valve by the maintenance worker. Therefore, workload required to achieve a liquid seal with an appropriate liquid level can be minimized.

In an example (Aspect 7) of Aspect 6, the controller controls the opening degree of the adjustment valve such that an opening degree of the adjustment valve when an internal pressure measured by the pressure gauge is at a first value is less than an opening degree of the adjustment valve when the internal pressure is at a second value that is greater than the first value.

In this aspect, when the internal pressure is reduced from the second value to the first value due to breakage of a seal, the opening degree of the adjustment valve is decreased, so that the amount of the separated liquid accumulated in the treatment container is increased. As a result, a liquid seal at an appropriate liquid level can be stably maintained.

In an example (an eighth aspect) of Aspect 5, the scrubber further includes: a liquid level meter that measures a liquid level of the separated liquid accumulated in the treatment container; and a controller configured to control an opening degree of the adjustment valve based on a measurement result of the liquid level meter.

In this aspect, the opening degree of the adjustment valve is controlled based on the measurement result of the liquid level. Such control eliminates the need for manual adjustment of the adjustment valve by the maintenance worker. As a result, workload required to achieve a liquid seal with an appropriate liquid level L is reduced.

In an example (Aspect 9) of Aspect 8, the controller controls the opening degree of the adjustment valve such that an opening degree of the adjustment valve when a liquid level measured by the liquid level meter is at a first value is less than an opening degree of the adjustment valve when the liquid level is at a second value that is greater than the first value.

In this aspect, when the liquid level of the separated liquid is reduced from the second value to the first value due to breakage of a seal, the opening degree of the adjustment valve is decreased, so that the amount of the separated liquid accumulated in the treatment container is increased. As a result, a liquid seal by an appropriate liquid level can be stably maintained.

In an example (Aspect 10) of any of Aspects 1 to 9, the scrubber further comprises a check valve placed on a flow path between the treatment container and the drainage pipe. The check valve prevents backflow of the separated liquid from the drainage pipe toward the treatment container. In this aspect, the check valve is placed between the treatment container and the drainage pipe. As a result, backflow of the separated liquid is prevented from the drainage pipe toward the treatment container.

A geothermal power generation system according to another aspect (Aspect 11) of this disclosure includes a production well that generates geothermal steam; a scrubber for geothermal power generation including: a treatment container that separates the generated geothermal steam into a separated gas and a separated liquid by treating the geothermal steam with a treatment liquid and has a steam supply opening to which the geothermal steam is supplied, and a gas release opening from which the separated gas is released; a drainage pipe placed below the treatment container to discharge the separated liquid; and a cooling mechanism that cools a portion of the treatment container between the steam supply opening and the drainage pipe; and a power-generating facility that generates power, using the separated gas.

According to this aspect, the portion of the treatment container between the steam supply opening and the drainage pipe is cooled by the cooling mechanism. Such a cooling results in suppression of the separated liquid from turning into mist due to heating by the geothermal steam. As a result, steam of the separated liquid containing impurities can be prevented from mixing with the geothermal steam to be discharged from the gas release opening. This leads to prevention from reduction in power generation efficiency, as well as the total amount of electricity produced, caused by the adhesion and deposition of impurities on power-generating facilities.

In the technique of Patent Document 1 (Japanese Utility Model Application Laid-Open Publication No. H03-83615), geothermal steam may be discharged from the drainage pipe along with a liquid containing impurities. In this situation, a sufficient amount of geothermal steam is not supplied to power-generating facilities and the generated power is decreased.

In view of the above circumstances, a scrubber for geothermal power generation according to one aspect of this disclosure includes: a treatment container that: separates geothermal steam into a separated gas and a separated liquid by treating the geothermal steam with a treatment liquid; and has a steam supply opening to which the geothermal steam is supplied, and a gas release opening from which the separated gas is released; and a drainage pipe placed below the treatment container to discharge the separated liquid. The treatment container has a liquid seal caused by accumulation of the separated liquid, and the liquid seal is positioned vertically downward of the treatment container.

According to this aspect, a liquid seal is formed vertically downward of the treatment container. As a result, compared to when there is no liquid seal in the treatment container, the geothermal steam is prevented from being discharged to the drainage pipe.

### DESCRIPTION OF REFERENCE SIGNS

100 . . . geothermal power generation system, 10 . . . treatment container, 10A . . . container bottom region, 10B . . . cooling target, 11 . . . sidewall, 12 . . . top face, 13 . . . bottom, 15 . . . steam supply opening, 16 . . . gas release opening, 17 . . . drainage opening, 20 . . . liquid injector, 21 . . . trunk pipe, 22 . . . branch pipe, 23 . . . sprayer, 30 . . . drainage pipe, 40A, 40B . . . cooling mechanism, 41 . . . cooling channel, 411 . . . drainage path, 42 . . . supply mechanism, 43 . . . cooling pipe, 44 . . . cooling fin, 50 . . . adjustment valve, 51 . . . pressure gauge, 52, 54 . . . controller, 53 . . . liquid level meter, 60 . . . check valve, 91 . . . production well, 92 . . . reduction well, 93 . . . scrubber for geothermal power generation, 94 . . . power-generating facility, 95 . . . condenser.

What is claimed is:

1. A scrubber for geothermal power generation, comprising:
a treatment container that:
separates geothermal steam into a separated gas and a separated liquid by treating the geothermal steam with a treatment liquid; and
has a steam supply opening to which the geothermal steam is supplied, and a gas release opening from which the separated gas is released;
a drainage pipe placed below the treatment container to discharge the separated liquid; and
a cooling mechanism that cools a portion of the treatment container between the steam supply opening and the drainage pipe.

2. The scrubber according to claim 1,
wherein the cooling mechanism includes:
a cooling channel placed in vicinity of the treatment container; and
a supply mechanism that supplies a coolant to the cooling channel.

3. The scrubber according to claim 1,
wherein the cooling mechanism is an air-cooling mechanism that cools the treatment container by heat exchange with external air.

4. The scrubber according to claim 1, wherein:
the treatment container has a liquid seal caused by accumulation of the separated liquid, and
the liquid seal is positioned vertically downward of the treatment container.

5. The scrubber according to claim 4, further comprising an adjustment valve placed on a flow path between the treatment container and the drainage pipe,
wherein the adjustment valve forms the liquid seal by adjusting a flow rate of the separated liquid supplied from the treatment container to the drainage pipe.

6. The scrubber according to claim 5, further comprising:
a pressure gauge that measures an internal pressure of the treatment container; and
a controller configured to control an opening degree of the adjustment valve based on a measurement result of the pressure gauge.

7. The scrubber according to claim 6,
wherein the controller controls the opening degree of the adjustment valve such that an opening degree of the adjustment valve when an internal pressure measured by the pressure gauge is at a first value is less than an opening degree of the adjustment valve when the internal pressure is at a second value that is greater than the first value.

8. The scrubber according to claim 5, further comprising:
a liquid level meter that measures a liquid level of the separated liquid accumulated in the treatment container; and
a controller configured to control an opening degree of the adjustment valve based on a measurement result of the liquid level meter.

9. The scrubber according to claim 8,
wherein the controller controls the opening degree of the adjustment valve such that an opening degree of the adjustment valve when a liquid level measured by the liquid level meter is at a first value is less than an opening degree of the adjustment valve when the liquid level is at a second value that is greater than the first value.

10. The scrubber according to claim 1, further comprising a check valve placed on a flow path between the treatment container and the drainage pipe,
wherein the check valve prevents backflow of the separated liquid from the drainage pipe toward the treatment container.

11. A geothermal power generation system comprising:
a production well that generates geothermal steam;
a scrubber for geothermal power generation including:
a treatment container that:
separates the generated geothermal steam into a separated gas and a separated liquid by treating the geothermal steam with a treatment liquid; and
has a steam supply opening to which the geothermal steam is supplied, and a gas release opening from which the separated gas is released;
a drainage pipe placed below the treatment container to discharge the separated liquid; and
a cooling mechanism that cools a portion of the treatment container between the steam supply opening and the drainage pipe; and
a power-generating facility that generates power, using the separated gas.
